(19) United States
(12) Patent Application Publication
(10) Pub. No.: US 2025/0137376 A1
(43) Pub. Date: May 1, 2025

(54) VANE OUTER SHROUD UNDERCUT GROOVE

(71) Applicant: PRATT & WHITNEY CANADA CORP., Longueuil (CA)

(72) Inventor: Lorenzo Sanzari, Montreal (CA)

(73) Assignee: PRATT & WHITNEY CANADA CORP., Longueuil, QU (CA)

(21) Appl. No.: 18/495,973

(22) Filed: Oct. 27, 2023

(51) Int. Cl. F01D 5/18; F01D 5/14

(52) U.S. Cl. CPC F01D 5/14

(57) ABSTRACT

A vane outer shroud for a gas turbine engine is disclosed. The vane outer shroud includes a vane coupled to the vane outer shroud, an area downstream of the vane through which a rotor blade rotates about an axis relative to the vane, and a groove formed in the vane outer shroud upstream and adjacent to a leading edge of the rotor blade. The groove is configured to recirculate air and/or gas radially inward toward the rotor blade.

### FIELD

The present disclosure relates to components in turbine engines, and more particularly, a vane outer shroud undercut groove.

### BACKGROUND

Gas turbine engines, such as those that power modern commercial and military aircraft and those that are used for land-based power generation, include a compressor section to pressurize a supply of air, a combustor section to burn a fuel in the presence of the pressurized air, and a turbine section to extract energy from the resultant combustion gases to generate thrust or electrical power.

A major source of gas path leakage in the turbine section is through the shrouded blade tips. Gas entering the vane outer shroud tends to radially escape through a gap between the vane outer should and shrouded blade tips. In that regard, the gap provides a path for gas to bypass the airfoils and leak through the blade tips instead of being converted into mechanical work.

### SUMMARY

A grooved vane outer shroud for a gas turbine engine is disclosed herein. The grooved vane outer shroud includes a vane coupled to the vane outer shroud, an area downstream of the vane through which a rotor blade rotates about an axis relative to the vane, and a groove formed in the vane outer shroud upstream and adjacent to a leading edge of the rotor blade. The groove is configured to recirculate air and/or gas radially inward toward the rotor blade.

In various embodiments, the groove is formed radially outward into the vane outer shroud. In various embodiments, the groove is formed in the vane outer shroud upstream and adjacent to a leading edge of a blade shroud of the rotor blade. In various embodiments, a separate groove is formed in the vane outer shroud upstream and adjacent to each leading edge of each rotor blade within a low-pressure turbine section of the gas turbine engine. In various embodiments, a depth of the groove is half of a width of the groove. In various embodiments, a depth of the groove is greater than half of a width of the groove. In various embodiments, the groove is configured to have a shape and wherein the shape is at least one of a semicircular shape, a V shape, or a spiral, hook-shape.

Also disclosed herein is a gas turbine engine. The gas turbine engine includes a vane, a rotor blade, and a vane outer shroud. The vane outer shroud includes the vane coupled to the vane outer shroud, an area downstream of the vane through which the rotor blade rotates about an axis relative to the vane, and a groove formed in the vane outer shroud upstream and adjacent to a leading edge of the rotor blade. The groove is configured to recirculate air and/or gas radially inward toward the rotor blade.

In various embodiments, the groove is formed radially outward into the vane outer shroud. In various embodiments, the groove is formed in the vane outer shroud upstream and adjacent to a leading edge of a blade shroud of the rotor blade. In various embodiments, the gas turbine engine further includes a plurality of rotor blades. In various embodiments, a separate groove is formed in the vane outer shroud upstream and adjacent to each leading edge of each of the plurality of rotor blades within a low-pressure turbine section of the gas turbine engine. In various embodiments, a depth of the groove is half of a width of the groove. In various embodiments, a depth of the groove is greater than half of a width of the groove. In various embodiments, the groove is configured to have a shape and wherein the shape is at least one of a semicircular shape, a V shape, or a spiral, hook-shape.

Also disclosed herein is an aircraft. The aircraft includes a gas turbine engine, The gas turbine engine includes a vane, a rotor blade, and a vane outer shroud. The vane outer shroud includes the vane coupled to the vane outer shroud, an area downstream of the vane through which the rotor blade rotates about an axis relative to the vane, and a groove formed in the vane outer shroud upstream and adjacent to a leading edge of the rotor blade. The groove is configured to recirculate air and/or gas radially inward toward the rotor blade.

In various embodiments, the groove is formed radially outward into the vane outer shroud. In various embodiments, the groove is formed in the vane outer shroud upstream and adjacent to a leading edge of a blade shroud of the rotor blade. In various embodiments, the aircraft further includes a plurality of rotor blades. In various embodiments, a separate groove is formed in the vane outer shroud upstream and adjacent to each leading edge of each of the plurality of rotor blades within a low-pressure turbine section of the gas turbine engine. In various embodiments, a depth of the groove is equal to or greater than half of a width of the groove. In various embodiments, the groove is configured to have a shape and wherein the shape is at least one of a semicircular shape, a V shape, or a spiral, hook-shape.

The present disclosure may include any one or more of the individual features disclosed above and/or below alone or in any combination thereof. The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a cross-sectional view of a gas-turbine engine, in accordance with various embodiments.

FIG. 2 illustrates an enlarged schematic cross-section of a portion of a low-pressure turbine section of the gas turbine engine of FIG. 1, in accordance with various embodiments.

FIG. 3A illustrates an enlarged section of a vane outer shroud with a semicircular undercut groove to forcibly recirculate air/gas inward toward a rotor blade, in accordance with various embodiments.

FIG. 3B illustrates an enlarged section of a vane outer shroud with a V-shaped undercut groove to forcibly recirculate air/gas inward toward a rotor blade, in accordance with various embodiments.

FIG. 3C illustrates an enlarged section of a vane outer shroud with a spiral, hook shaped undercut groove to forcibly recirculate air/gas inward toward a rotor blade, in accordance with various embodiments.

### DETAILED DESCRIPTION

The detailed description of embodiments herein makes reference to the accompanying drawings, which show embodiments by way of illustration. While these embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not for limitation. For example, any reference to singular includes plural embodiments, and any reference to more than one component or step may include a singular embodiment or step. Also, any reference to attached, fixed, connected or the like may include permanent, removable, temporary, partial, full and/or any other possible attachment option. Further, any steps in a method discussed herein may be performed in any suitable order or combination. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

As stated previously, gas entering the vane outer shroud tends to radially escape through a gap between the vane outer should and shrouded blade tips. In that regard, the gap provides a path for gas to bypass the airfoils and leak through the blade tips instead of being converted into mechanical work. Disclosed herein, in various embodiments, is a grooved vane outer shroud for a gas turbine engine that reduces blade tip leakages for improving turbine efficiency, reducing temperatures, and improving specific fuel consumption. In various embodiments, the grooved vane outer shroud includes a groove undercut in the vane outer shroud located near the blade tip. In various embodiments, the groove undercut may be a semicircular groove, a V-shaped groove, or a spiral, hook-shaped groove, among others. By providing the grooved undercut in the vane outer shroud located near the blade tip, a local aerodynamic recirculation of air is generated that forms a barrier which discourages air to leak through the blade tip. In various embodiments, the grooved undercut may be provided in one or more stages within the turbine section. In various embodiments, the grooved undercut may be provided in all stages of the turbine section.

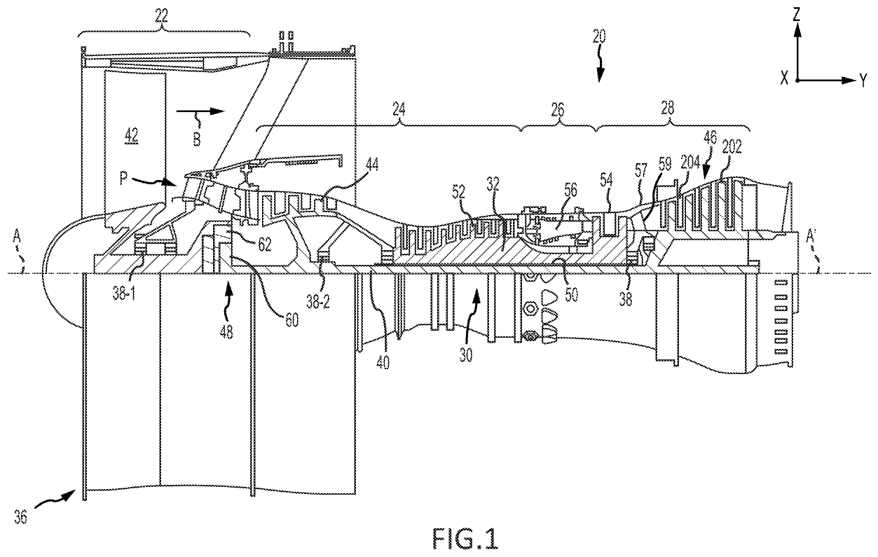

With reference to FIG. 1, a cross sectional view, in an axial direction, a gas turbine engine 20 is illustrated shown according to various embodiments. As used herein, “aft” refers to the direction associated with the tail (e.g., the back end) of an aircraft, or generally, to the direction of exhaust of the gas turbine engine. As used herein, “forward” refers to the direction associated with the nose (e.g., the front end) of an aircraft, or generally, to the direction of flight or motion, or to the direction associated with the inlet of the gas turbine engine. As utilized herein, radially inward refers to the negative R direction (towards axis A-A′) and radially outward refers to the R direction (away from the A-A′ axis). An A-R-C axis is shown in various drawings to illustrate the relative position of various components.

Gas turbine engine 20 may be a two-spool turbofan that generally incorporates a fan section 22, a compressor section 24, a combustor section 26, and a turbine section 28. In operation, fan section 22 may drive fluid, i.e. air, along a path of bypass airflow B while compressor section 24 may drive the fluid along a core flow path P for compression and communication into combustor section 26 then expansion through turbine section 28. Although depicted as a turbofan gas turbine engine 20 herein, it should be understood that the concepts described herein are not limited to use with turbofans as the teachings may be applied to other types of turbine engines.

Gas turbine engine 20 may generally include a low-speed spool 40 and a high-speed spool 32 mounted for rotation about an engine central longitudinal axis A-A′ relative to an engine static structure 36 or engine case via several bearing systems 38, 38-1, 38-2, etc. Engine central longitudinal axis A-A′ is oriented in the y-direction on the provided X-Y-Z axes. It should be understood that various bearing systems 38 at various locations may alternatively or additionally be provided, including for example, bearing system 38, bearing system 38-1, bearing system 38-2, etc.

Low-speed spool 40 may generally include an inner shaft 40 that interconnects a fan 42, a low-pressure compressor 44, and a low-pressure turbine 46. Inner shaft 40 may be connected to fan 42 through a geared system 48 that may drive the fan 42 at a lower speed than low-speed spool 40. Geared system 48 may include a gear assembly enclosed within a gear housing. Geared system 48 couples the inner shaft 40 to a rotating fan structure. The geared system 48 includes a gear assembly 60 enclosed within a gear housing 62. The gear assembly 60 couples the inner shaft 40 to a rotating fan structure.

High-speed spool 32 may include an outer shaft 50 that interconnects a high-pressure compressor 52 and high-pressure turbine 54. A combustor section 56 may be located between high-pressure compressor 52 and high-pressure turbine 54. A mid-turbine frame 57 of engine static structure 30 may be located generally between high-pressure turbine 54 and low-pressure turbine 46. Mid-turbine frame 57 may support one or more bearing systems 38 in turbine section 28. Inner shaft 40 and outer shaft 50 may be concentric and rotate via bearing systems 38 about the engine central longitudinal axis A-A′, which is collinear with their longitudinal axes. As used herein, a “high pressure” compressor or turbine experiences a higher pressure than a corresponding “low pressure” compressor or turbine.

The core airflow may be compressed by low-pressure compressor 44 then high-pressure compressor 52, mixed and burned with fuel in the combustor section 56, then expanded over high-pressure turbine 54 and low-pressure turbine 46. The mid-turbine frame 57 includes airfoils 59 which are in the core airflow path C. Turbines 46, 54 rotationally drive the respective low-speed spool 40 and high-speed spool 32 in response to the expansion. It will be appreciated that each of the positions of the fan section 22, compressor section 24, combustor section 26, turbine section 28, and geared system 48 may be varied. In various embodiments, geared system 48 may be located aft of combustor section 26 or even aft of turbine section 28, and fan section 22 may be positioned forward or aft of the location of geared system 48.

The gas turbine engine 20, in various embodiments, is a high-bypass geared aircraft engine. In various embodiments, the gas turbine engine 20 bypass ratio is greater than about six (6), with an example embodiment being greater than about ten (10), the geared system 48 is an epicyclic gear train, such as a planetary gear system or other gear system, with a gear reduction ratio of greater than about 2.3 and the low-pressure turbine 46 has a pressure ratio that is greater than about five. In various embodiments, the gas turbine engine 20 bypass ratio is greater than about ten (10:1), the fan diameter is significantly larger than that of the low-pressure compressor 44, and the low-pressure turbine 46 has a pressure ratio that is greater than about five 5:1. Low-pressure turbine 46 pressure ratio is pressure measured prior to inlet of low-pressure turbine 46 as related to the pressure at the outlet of the low-pressure turbine 46 prior to an exhaust nozzle. The geared system 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

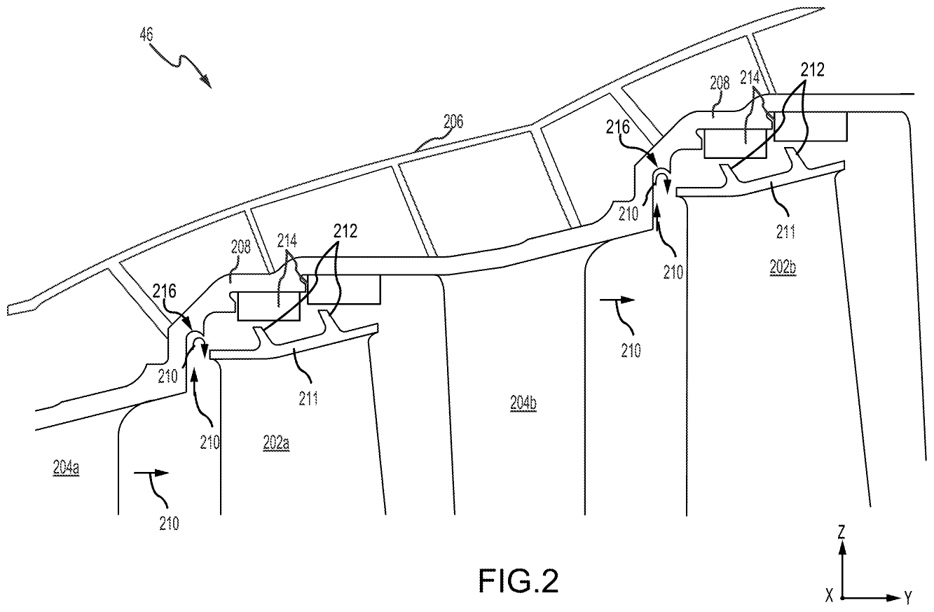

With reference now to FIGS. 1 and 2, turbine section 28 includes a plurality of rotor blades 202 and a plurality of vanes 204. In various embodiments, the first rotor blade 202a and the second rotor blade 202b are each configured to rotate about the axis A-A′ relative to first vane 204a and second vane 204b in response to receiving a flow of fluid from the combustor section 26. Thus, kinetic energy from the flow is converted to mechanical energy, or torque, by the first rotor blade 202a and the second rotor blade 202b. Each of the first vane 204a and the second vane 204b are coupled to a frame 206 of the low-pressure turbine 46 via a vane outer shroud 208 and each of the first vane 204a and the second vane 204b condition the flow of air/gas 210 between the first rotor blade 202a and the second rotor blade 202b, respectively. The second vane 204b thus acts as a stator and does not rotate relative to the axis A-A′.

In various embodiments, each of the first rotor blade 202a and the second rotor blade 202b include a blade tip 212 coupled to the rotor blade via a blade shroud 211. In various embodiments, a blade outer air seal (BOAS) 214 is located radially outward from the first rotor blade 202a and the second rotor blade 202b. The low-pressure turbine 46 may include multiple BOASs 214 positioned adjacent each other circumferentially and surrounding the longitudinal axis A-A′ of FIG. 1. The BOAS 214 are designed to function as a seal to reduce axial leakage of the air/gas 210 between the blade tip 212 of the first rotor blade 202a and the second rotor blade 202b and the frame 206. In particular, the BOAS 214 has an inner surface that forms a seal along with the blade tip 212 of the first rotor blade 202a and the second rotor blade 202b. In that regard, the core airflow may contact the radially inner surface of the BOAS 214.

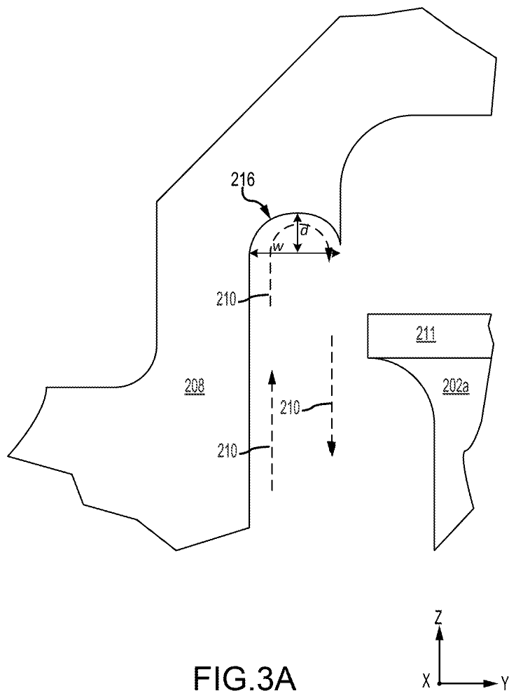

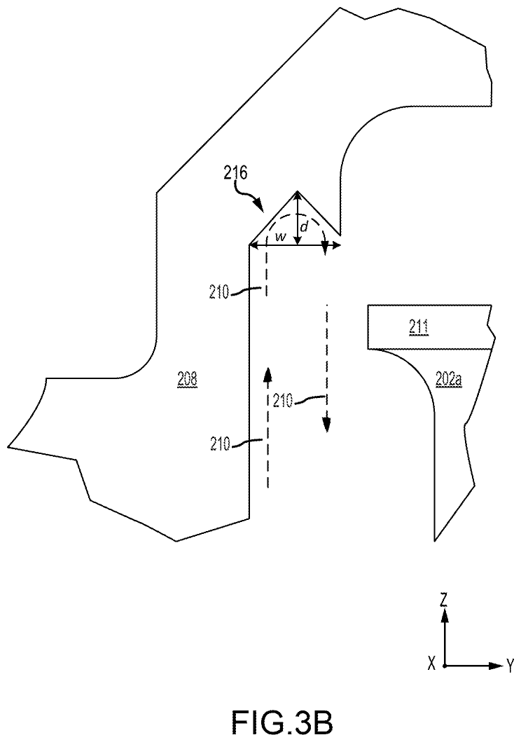

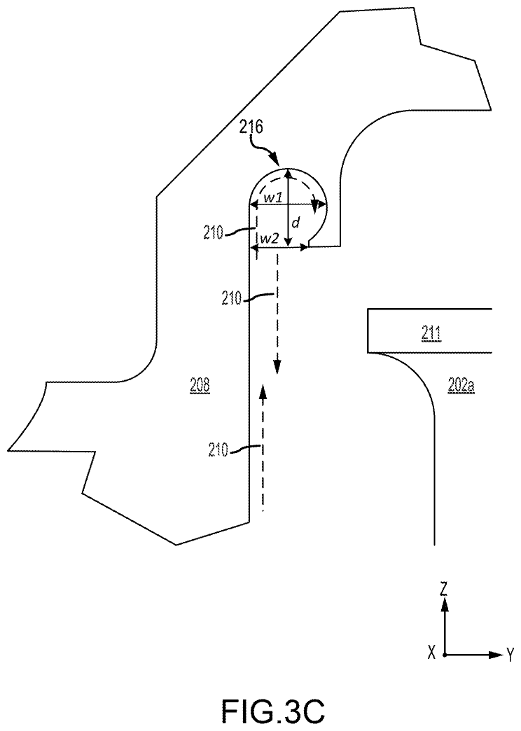

In various embodiments, the BOAS 214 are designed to function as a seal to reduce axial leakage of the air/gas 210 between the blade tip 212 of the first rotor blade 202a and the second rotor blade 202b and the frame 206. However, even with the BOAS 214, the air/gas 210 gas entering the vane outer shroud 208 still tends to radially escape through a gap between the vane outer should 208 and blade tips 212. In that regard, the gap provides a path for the air/gas 210 to bypass the first rotor blade 202a and the second rotor blade 202b and leak through the blade tips 212 instead of being converted into mechanical work. In that regard, a groove 216 may be formed in the vane outer shroud 208 adjacent a leading edge of the blade tip 212 of a respective one of the first rotor blade 202a and/or the second rotor blade 202b. In various embodiments, the groove 216 may be formed upstream, i.e. forward in an y-direction of the rotor blade, and circumferentially within the vane outer shroud 208 adjacent a leading edge of the blade shroud 211 of the respective one of the first rotor blade 202a and/or the second rotor blade 202b. In various embodiments, the groove 216 may have a semicircular shape as illustrated in FIG. 3A, a ‘V’ shape as illustrated in FIG. 3B, or a spiral, hook shape groove as illustrated in FIG. 3C, among others. While the description of FIG. 2 is described with regard to low-pressure turbine 46, the illustrative embodiments are not limited to only low-pressure turbines. In that regard, the grooves 216 may also be implemented in a power turbine or a high-pressure turbine, among others.

In various embodiments, a depth d in the z-direction of the groove 216 into the vane outer shroud 208 is half of the width w of the groove 216, i.e. a ratio of depth d in the z-direction of the groove 216 to the width w of the groove 216 of 0.5 to 1. In various embodiments, the depth d in the z-direction of the groove 216 into the vane outer shroud 208 is at greater than half of the width w of the shaped groove. i.e. a ratio of >0.5 to 1. In that regard, a greater depth d provides for more recirculation of the air/gas 210 thereby forcing the air/gas radially inward toward the first rotor blade 202a and the second rotor blade 202b thereby tending to increase turbine efficiency, reduce temperatures, and improve specific fuel consumption. That is, by providing the groove 216 in the vane outer shroud 208 located near the blade shroud 211, a local aerodynamic recirculation of air is generated that forms a barrier which discourages the air/gas 210 to leak through the blade tip 212. In various embodiments, the groove 216 may be provided in one or more stages within the turbine section. In various embodiments, the groove 216 may be provided in all stages of the turbine section.

Referring particularly to FIG. 3A, in accordance with various embodiments, an enlarged section of a vane outer shroud with a semicircular undercut groove to forcibly recirculate air/gas inward toward a rotor blade is illustrated. In various embodiments, the groove 216 may be formed in the vane outer shroud 208 adjacent a leading edge of the blade shroud 211 of the first rotor blade 202a. In various embodiments, the groove 216 has a semicircular shape. In various embodiments, the groove 216 has a depth d that is half of the width w of the groove 216, i.e. a ratio of depth d in the z-direction of the groove 216 to the width w of the groove 216 of 0.5 to 1. In various embodiments, the depth d in the z-direction of the groove 216 into the vane outer shroud 208 is at greater than half of the width w of the shaped groove, i.e. a ratio of >0.5 to 1. In various embodiments, maximum depth d to width w ratio may have a maximum depth d otherwise the air/gas 210 may not recirculate properly. In that regard, in various embodiments, depth d to width w ratio is less than 5, e.g. d/w<5. Accordingly, in various embodiments, a greater depth d provides for more recirculation of the air/gas 210 thereby forcing the air/gas radially inward toward the first rotor blade 202a thereby tending to increase turbine efficiency, reduce temperatures, and improve specific fuel consumption.

Referring particularly to FIG. 3B, in accordance with various embodiments, an enlarged section of a vane outer shroud with a V-shaped undercut groove to forcibly recirculate air/gas inward toward a rotor blade is illustrated. In various embodiments, the groove 216 may be formed in the vane outer shroud 208 adjacent a leading edge of the blade shroud 211 of the first rotor blade 202a. In various embodiments, the groove 216 has a ‘V’ shape. In various embodiments, the groove 216 has a depth d that is half of the width w of the groove 216, i.e. a ratio of depth d in the z-direction of the groove 216 to the width w of the groove 216 of 0.5 to 1. In various embodiments, the depth d in the z-direction of the groove 216 into the vane outer shroud 208 is at greater than half of the width w of the shaped groove, i.e. a ratio of >0.5 to 1. In various embodiments, maximum depth d to width w ratio may have a maximum depth d otherwise the air/gas 210 may not recirculate properly. In that regard, in various embodiments, depth d to width w ratio is less than 5, e.g. d/w<5. Accordingly, in various embodiments, a greater depth d provides for more recirculation of the air/gas 210 thereby forcing the air/gas radially inward toward the first rotor blade 202a thereby tending to increase turbine efficiency, reduce temperatures, and improve specific fuel consumption.

Referring particularly to FIG. 3C, in accordance with various embodiments, an enlarged section of a vane outer shroud with a spiral, hook shaped undercut groove to forcibly recirculate air/gas inward toward a rotor blade is illustrated. In various embodiments, the groove 216 may be formed in the vane outer shroud 208 adjacent a leading edge of the blade shroud 211 of the first rotor blade 202a. In various embodiments, the groove 216 has a spiral, hook shape. In various embodiments, the groove 216 has a depth d that is half of the width w1 of the groove 216, i.e. a ratio of depth d in the z-direction of the groove 216 to the width w1 of the groove 216 of 0.5 to 1. In various embodiments, the depth d in the z-direction of the groove 216 into the vane outer shroud 208 is at greater than half of the width w1 of the shaped groove, i.e. a ratio of >0.5 to 1. In various embodiments, maximum depth d to width w ratio may have a maximum depth d otherwise the air/gas 210 may not recirculate properly. In that regard, in various embodiments, depth d to width w ratio is less than 5, e.g. d/w<5. In various embodiments, the spiral, hook shaped undercut groove is formed such that a width w2 of the opening of the spiral, hook shaped undercut groove is less than the width w/of the groove 216. In various embodiments, the width w2 is between 0.5 and 0.75 of width w1. In various embodiments, the width w2 is between 0.55 and 0.70 of width w1. In various embodiments, the width w2 is between 0.60 and 0.65 of width w1. Accordingly, in various embodiments, a greater depth d provides for more recirculation of the air/gas 210 thereby forcing the air/gas radially inward toward the first rotor blade 202a thereby tending to increase turbine efficiency, reduce temperatures, and improve specific fuel consumption.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A vane outer shroud for a gas turbine engine, the vane outer shroud comprising:
a vane coupled to the vane outer shroud;
an area downstream of the vane through which a rotor blade rotates about an axis relative to the vane; and
a groove formed in the vane outer shroud upstream and adjacent to a leading edge of the rotor blade, wherein the groove is configured to recirculate air and/or gas radially inward toward the rotor blade.

2. The vane outer shroud of claim 1, wherein the groove is formed radially outward into the vane outer shroud.

3. The vane outer shroud of claim 1, wherein the groove is formed in the vane outer shroud upstream and adjacent to a leading edge of a blade shroud of the rotor blade.

4. The vane outer shroud of claim 1, wherein a separate groove is formed in the vane outer shroud upstream and adjacent to each leading edge of each rotor blade within a low-pressure turbine section of the gas turbine engine.

5. The vane outer shroud of claim 1, wherein a depth of the groove is half of a width of the groove.

6. The vane outer shroud of claim 1, wherein a depth of the groove is greater than half of a width of the groove.

7. The vane outer shroud of claim 1, wherein the groove is configured to have a shape and wherein the shape is at least one of a semicircular shape, a V shape, or a spiral, hook-shape.

8. A gas turbine engine comprising:
a vane;
a rotor blade; and
a vane outer shroud, the vane outer shroud comprising:
the vane coupled to the vane outer shroud;
an area downstream of the vane through which the rotor blade rotates about an axis relative to the vane; and
a groove formed in the vane outer shroud upstream and adjacent to a leading edge of the rotor blade, wherein the groove is configured to recirculate air and/or gas radially inward toward the rotor blade.

9. The gas turbine engine of claim 8, wherein the groove is formed radially outward into the vane outer shroud.

10. The gas turbine engine of claim 8, wherein the groove is formed in the vane outer shroud upstream and adjacent to a leading edge of a blade shroud of the rotor blade.

11. The gas turbine engine of claim 8, further comprising:
a plurality of rotor blades, wherein a separate groove is formed in the vane outer shroud upstream and adjacent to each leading edge of each of the plurality of rotor blades within a low-pressure turbine section of the gas turbine engine.

12. The gas turbine engine of claim 8, wherein a depth of the groove is half of a width of the groove.

13. The gas turbine engine of claim 8, wherein a depth of the groove is greater than half of a width of the groove.

14. The gas turbine engine of claim 8, wherein the groove is configured to have a shape and wherein the shape is at least one of a semicircular shape, a V shape, or a spiral, hook-shape.

15. An aircraft comprising:
a gas turbine engine, the gas turbine engine comprising:
a vane;
a rotor blade; and
a vane outer shroud, the vane outer shroud comprising:
the vane coupled to the vane outer shroud;
an area downstream of the vane through which the rotor blade rotates about an axis relative to the vane; and
a groove formed in the vane outer shroud upstream and adjacent to a leading edge of the rotor blade, wherein the groove is configured to recirculate air and/or gas radially inward toward the rotor blade.

16. The aircraft of claim 15, wherein the groove is formed radially outward into the vane outer shroud.

17. The aircraft of claim 15, wherein the groove is formed in the vane outer shroud upstream and adjacent to a leading edge of a blade shroud of the rotor blade.

18. The aircraft of claim 15, further comprising:
a plurality of rotor blades, wherein a separate groove is formed in the vane outer shroud upstream and adjacent to each leading edge of each of the plurality of rotor blades within a low-pressure turbine section of the gas turbine engine.

19. The aircraft of claim 15, wherein a depth of the groove is equal to or greater than half of a width of the groove.

20. The aircraft of claim 15, wherein the groove is configured to have a shape and wherein the shape is at least one of a semicircular shape, a V shape, or a spiral, hook-shape.
